(19) United States
(12) Patent Application Publication
(10) Pub. No.: US 2006/0115616 A1
(43) Pub. Date: Jun. 1, 2006

(54) Protectors for protecting timber poles against subsoil decay

(75) Inventors: Albin A. W. Baecker, Westville (ZA); Michael R. Behr, Durban (ZA)

Correspondence Address: SENNIGER POWERS, ONE METROPOLITAN SQUARE, 16TH FLOOR, ST LOUIS, MO, 63102, US

(73) Assignee: Biotrans UK Limited, Dundee (GB)

(21) Appl. No.: 10/537,380

(22) PCT Filed: Nov. 28, 2003
(86) PCT No.: PCT/IB03/05484

§ 371 Date: Dec. 6, 2005

(30) Foreign Application Priority Data
Dec. 4, 2002 (ZA) 2002/9839

(51) Int. Cl. B32B 33/00

(52) U.S. Cl. 428/40.1; 428/43

(57) ABSTRACT

The invention relates to a protector for protecting a timber pole against subsoil decay. The protector, referred to specifically as a field liner, comprises a flexible sheet element in the form of a laminate structure including a plurality of material layers that provide the sheet element with required properties to serve as a field liner. For its field liner application the sheet element is used either in its sheet form as such, or in a sleeve form, both forms providing for the sheet element to be wrapped around a pole to be protected, the sleeve form providing for such wrapping after having been applied over the pole to cover the region to be protected. An adhesive substance applied to a suitable region of the sheet element then permits securing of the sheet element on the pole in its operative configuration tightly wrapped around the pole.

THIS INVENTION relates to protectors for protecting timber poles against subsoil decay.

It is known, as a method of primary pre-treatment of a timber pole to be supported in a body of soil, to apply a protector, also known as and herein referred as a field liner, to the pole, for covering the region of the pole that will be disposed within the soil body. A known field liner comprises a sleeve, of a synthetic plastics material, which, in use, fits snugly around the pole to be treated thereby, along the region of the pole to be covered, the known method of fitting this field liner on the pole providing for the sleeve to be heat shrunk on the pole.

The synthetic plastics material forming a field liner generally is a liquid impermeable, non-biodegradable material such as polypropylene, or a low density polyethylene. By its application on a pole it covers the optimal fungal growth region of the pole, thereby regulating at sub-optimal levels the air and moisture content of the said region, and isolating it from nitrogenous compounds that exist in soil, all of which are required for fungal growth to occur. The field liner thus specifically prevents fungal growth from occurring. Since it is applied in the form of a sleeve, of which the operative lower end is open, the transverse surface of the butt of the pole remains uncovered and by not encapsulating the butt, it cannot become anaerobic and, as such, the field liner also prevents subsoil decay by anaerobic bacteria.

The heat shrink method of applying a field liner on a pole, although effective, has proved to be difficult to carry out in practice, particularly in a cheap and time efficient manner and it is thus an object of this invention to provide a field liner in respect of which the application on a pole is facilitated.

It has also been found that preservatives in standing poles migrate downwards through outer sapwood vessels and are then lost to the soil by leaching from the poles, particularly from longitudinal and transverse faces of the poles near the butt ends thereof and that are in soil contact. The preservative loss is reduced by known field liners, but it remains an object of this invention to ameliorate the problem of preservative loss still further.

According to the invention there is provided a field liner for protecting a timber pole against subsoil decay, which includes a sheet element in the form of a laminate structure including a first layer of a flexible, liquid impermeable, non-biodegradable synthetic plastics film material that contains a dry film biocide therein and a second layer of a flexible, liquid impermeable, non-biodegradable synthetic plastics film material that is tear resistant, the sheet element being configured to permit wrapping thereof around a pole for covering the region of the pole to be protected and having an adhesive substance applied thereto in a region thereof that permits securing of the location of the sheet element on a pole when wrapped around the pole with its first layer abutting the pole by adhering the said region of the sheet element to an opposing region of the sheet element when wrapped around the pole.

A first embodiment of such a field liner provides for the sheet element to be configured to define a rectangular configuration, that permits wrapping thereof around a pole by winding it on the pole, the adhesive substance being applied to the sheet element as an adhesive strip along an operative longitudinal edge region thereof.

The sheet element of such a field liner may be provided on a roll including a plurality of sheet elements, being separable from the roll by severing along a defined line of weakness, e.g. a line of perforations.

A second embodiment of the field liner of the invention provides for the sheet element to be configured to define an elongate sleeve that has the first layer of material forming the operative inside thereof and the second layer of material forming the operative outside thereof, the sleeve permitting loose location on a pole for covering the region of the pole to be protected and hence wrapping around the pole into a tight configuration of the sheet element on the pole, the adhesive substance thus being applied externally on the second layer of material in a region thereof that permits securing of the location of the sheet element in its said tight configuration on a pole when wrapped around the pole by adhering the said region to an opposing region of the sheet element when wrapped around the pole in the said tight configuration thereof.

One end of the sleeve defined by the sheet element of such a field liner may be at least partially sealed to form a pocket, the at least partially sealed end of the sleeve, in use, serving to determine the location of the sleeve on a pole by preventing the butt end of the pole to extend beyond the said at least partially sealed end of the sleeve. When so partially sealed, the pocket formation will have an opening therein that, in the operative configuration of the field liner on a pole will still permit water drainage from the field liner as hereinafter explained.

The sheet element of this second embodiment field liner, in its configuration in which it defines an elongate sleeve, also may be provided on a roll including a plurality of such sheet elements, being separable from the roll by severing along a defined line of weakness, which may again be a line of perforations.

For both the above embodiment field liners, the first layer of the sheet element may be formed of polypropylene film, or any other like suitable synthetic plastics material. The dry film biocide contained in the first layer of the sheet element may be of a type that provides for the protection of the sheet element against preservative-resistant microorganisms.

The material forming the first layer of the sheet element also may contain an insecticide compound therein that can protect the sleeve against termite attack, a typical insecticide compound being the pyrethroid insecticide, Deltamethrin.

Also for both the above embodiments of field liners, in accordance with the invention, the second layer of the sheet element may be formed of one of low density polyethylene and high density polyethylene. The second layer of material particularly is formed of high density polyethylene that permits crimping of a segment of the sheet element that, in use, extends beyond the butt end of a pole around which the sheet element is wrapped. The second layer of the sheet element also may contain an insecticide compound which again may be the pyrethroid insecticide, Deltamethrin.

A field liner that includes a sheet element of materials as hereinabove defined is particularly suitable for use on poles containing a water borne wood preservative, such as copper-chrome-arsenate, and the like.

The sheet element of both embodiment field liners, in accordance with the invention, also may include a third layer formed of a flexible aluminium film that is vapour impermeable and that is laminated between the said first layer and the said second layer of the sheet element. The said third layer renders the sleeve resistant to fume penetration and, as such, the field liner is rendered particularly suitable for use on poles containing oil borne wood preservatives such as creosote, pentachlorophenol, and the like. For such a field liner, the aluminium film provides the sheet element with crimping qualities as hereinabove envisaged.

Further according to the invention, the adhesive substance applied to both embodiment field liners as above defined may comprise an adhesive sealant and may be covered by a peel-off strip that can form a part of the field liner and that can be peeled-off prior to or during application of the field liner onto a pole.

The effective operative length of the sheet element of both embodiment field liners as above defined particularly is determined by the region of the pole to be covered thereby, being at least the region of the pole to be disposed subsoil, in the operative configuration of the pole. The length of the sheet element also may be such that the sheet element, in the operative configuration thereof, when secured on a pole, can extend beyond the butt end of the pole as hereinabove envisaged.

The invention extends also to a roll of field liners, in accordance with the invention, in which the sheet elements of the field liners form the roll and are separable from the roll by severing thereof along defined lines of weakness, e.g. lines of perforations.

Still further, the invention extends to the combination of a pole and a field liner, in accordance with the invention, with the field liner applied to the pole.

The mode of application of the field liner of the invention on a pole clearly is determined by the configuration of the field liner. For an embodiment field liner including merely a substantially rectangular sheet element, the sheet element is tightly wound around the pole. For the embodiment field liner in which the sheet element thereof forms a sleeve, the sleeve is located over the pole and then wrapped around the pole. For both embodiments, the adhesive substance provides for the secure location of the field liner following wrapping thereof around a pole.

Further features of the field liner of the invention are described hereafter, with reference to two examples of field liners that are illustrated in the accompanying diagrammatic drawings. In the drawings:

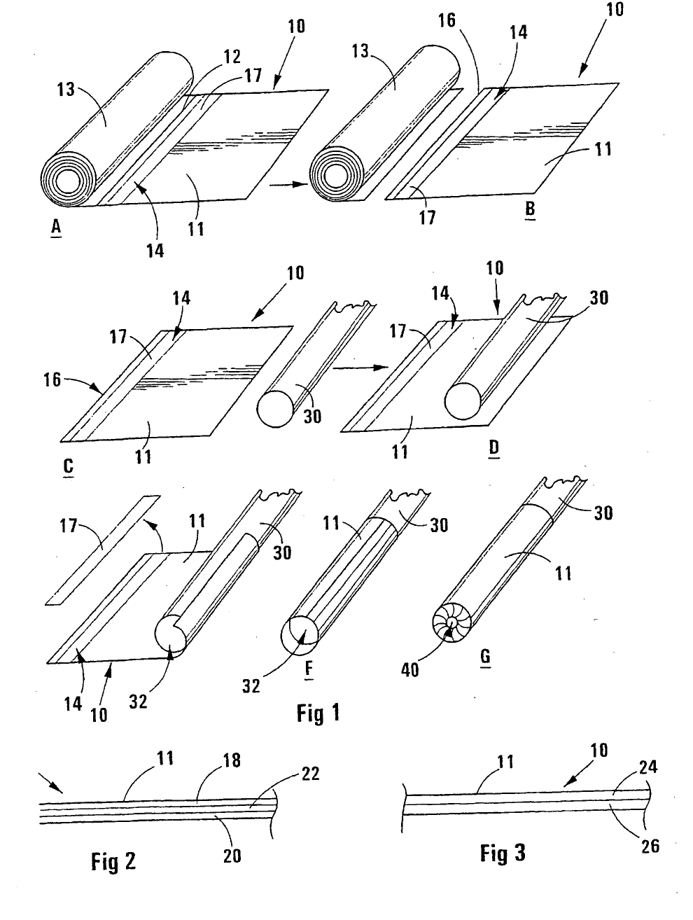

FIG. 1 illustrates in three dimensions the configuration of a first embodiment of a field liner for protecting a timber pole against subsoil decay, in accordance with the invention, and its mode of application onto a timber pole;

FIG. 2 shows in side view a first possible configuration of a portion of a sheet element for forming a field liner, in accordance with the invention;

FIG. 3 shows in side view a second possible configuration of a portion of a sheet element for forming a field liner, in accordance with the invention; and

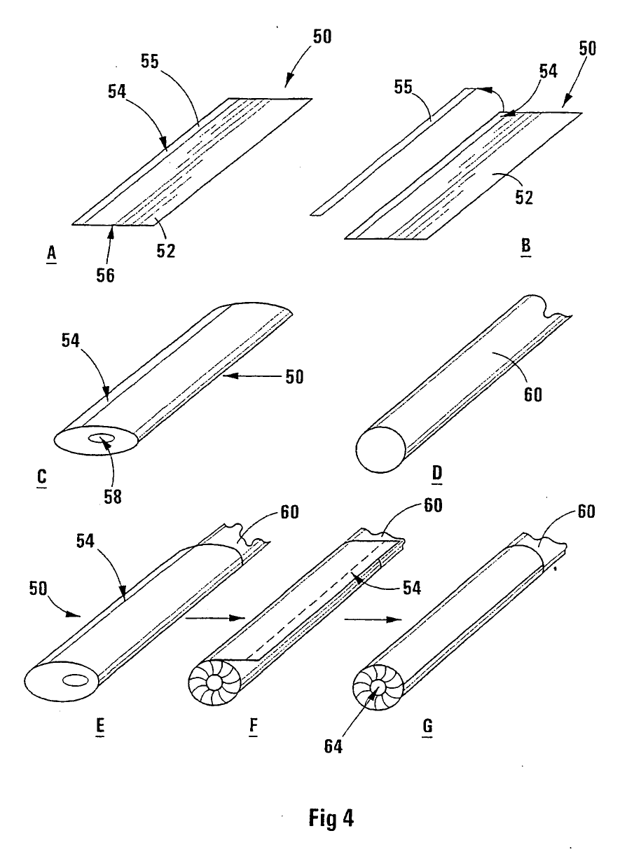

FIG. 4 illustrates in three-dimensions the configuration of a second embodiment of a field liner for protecting a timber pole against subsoil decay, in accordance with the invention, and its mode of application onto a timber pole.

Referring initially to FIGS. 1 to 3 of the drawings, a first embodiment of a field liner for protecting a timber pole against subsoil decay, in accordance with the invention, is designated generally by the reference numeral 10. The field liner 10 comprises a sheet element 11 that defines a substantially rectangular configuration and that is separable from a roll 13 including a plurality of such field liners. Particularly, a field liner 10 is separable from the roll 13 by severing the field liner from the roll 13 along a line defined by perforations 12.

The sheet element 11 has a strip 14 of an adhesive sealant applied thereto along the operative length thereof, adjacent the operative longitudinal edge 16 thereof, the adhesive sealant having a peel-off strip 17 applied thereto, for covering the strip 14 while the sheet element 11 forms a part of the roll 13.

The sheet element 11 forming the field liner 10 is in the form of a laminate structure, one particular configuration of this sheet element, as shown in FIG. 2, including a first layer 18, that is formed of a flexible, liquid impermeable, non-biodegradable synthetic plastics film material such as of polypropylene film, a second layer 20, that is formed of a flexible, liquid impermeable, non-biodegradable synthetic plastics film material that is tear resistant, such as low density polyethylene film, and a third layer 22, of a flexible aluminium film that is vapour impermeable and that is laminated between the first layer 18 and the second layer 20.

An alternative configuration of the sheet element 11 is illustrated in FIG. 3 of the drawings and includes only a first layer 24 and a second layer 26 that are the equivalent of the layers 18 and 20 respectively and that are laminated directly onto one another. The material forming the layers 18 and 24, respectively, of the two configurations of the sheet element 11 contain a dry film biocide therein and, optionally, also an insecticide compound such as the pyrethroid insecticide, Deltamethrin. The materials forming the respective layers, 20 and 26, of the two configurations of the sheet element 11 also may have an insecticide compound contained therein which, again, may be the pyrethroid insecticide, Deltamethrin.

In order to apply the field liner 10 to a timber pole 30, a sheet element 11 forming the field liner 10 is first separated from a roll 13 (see FIG. 1B), whereafter it is placed on a substantially planar work surface, where the timber pole is placed on the sheet element 11 (see FIGS. 1C and 1D). The peel-off strip 17 is then removed from the adhesive strip 14 (see FIG. 1E), whereafter the sheet element 11 is wound onto the timber pole 30, until fully wound thereon (see FIGS. 1E and 1F). Thereafter, the adhesive sealant serves to secure the sheet element 11 on the pole 30.

The effective length of the sheet element 11 forming the field liner 10 particularly is such that it covers the entire region of the pole 30 that will be disposed subsoil, in use, while extending also beyond the butt 32 of the pole, as is clearly illustrated. The segment of the sheet element 11 extending beyond the butt of the pole can then be crimped to cover partially this butt of the pole (see FIG. 1G), this crimping being facilitated by the aluminium film 22, if the sheet element 11 is formed of layers as shown in FIG. 2. If the sheet element 11 is of the configuration as shown in FIG. 3, the layer 26 can be formed of high density polyethylene film, particularly such a film that will permit crimping also.

A field liner formed of a sheet element as shown in FIG. 2 is particularly suitable for use on poles containing an oil borne wood preservative such as creosote, pentachlorophenol, or the like, the aluminium film being vapour impermeable and thus resisting fume penetration. A field liner formed of a sheet element as shown in FIG. 3 is particularly suitable for use on poles containing a water borne wood preservative, such as copper-chrome-arsenate, or the like, in respect of which fume penetration is not a factor and an aluminium film is thus not required.

Crimping of the field liner over the butt of a pole particularly serves to at least reduce leaching of preservative from the pole when disposed in its operative upright configuration in a body of soil, the remaining aperture 40, that is still defined, permitting water drainage and hence ensuring that the butt of the pole cannot become anaerobic and thus be exposed to subsoil decay by anaerobic bacteria.

Referring now to FIG. 4 of the drawings, a second embodiment of a field liner for protecting a timber pole against subsoil decay, in accordance with the invention, is designated generally by the numeral 50. The field liner 50 is formed of a sheet element 52 that is configured to form an elongate sleeve (see FIG. 4C), the sleeve, when disposed in a flat configuration as shown in FIGS. 4A and 4B, having a strip 54 of an adhesive sealant applied thereto along a longitudinal edge thereof. The strip 54 is covered by a peel-off strip 55 which can be removed from the field liner prior to the application thereof onto a pole (see FIG. 4B). One end 56 of the field liner 50 is partially sealed, the field liner 50 thus forming an effective pocket that has a hole 58 therein, as is shown clearly in FIG. 4C.

The sheet element 52 forming the sleeve again is in the form of a laminate structure, particularly a structure equivalent to the structure of the sheet element 11 of the field liner 10 as above described, with reference to FIGS. 2 and 3 of the drawings.

It is envisaged that the field liner 50 can be provided as a separate unit or, alternatively, in a roll form from which individual field liners are separable. The effective length of the sleeve is such that the field liner 50 can cover the area of a pole to be protected by being located over the pole, the partially sealed end 56 of the sleeve facilitating the required location of the field liner 50 on a pole.

It will be appreciated that the effective diameter of the sleeve is substantially larger than that of a pole on which the body is to be located, this being apparent from FIGS. 4C and 4D. For the application of the field liner 50 on a pole 60, the pole 60 is inserted into the sleeve until the butt of the pole bears against the partially sealed end of the sleeve. The sleeve is then wrapped tightly around the pole, whereafter the strip 54 of the adhesive sealant can serve to secure the field liner on the pole. Crimping of the excess material provided adjacent the butt of the pole can again be effected in order to cover this butt of the pole in a configuration in which leaching of preservative from the pole, while the pole is disposed in an operative upright configuration in a soil body, is effectively reduced. An opening 64 again remains in order to permit required water drainage and, thereby, prevent subsoil decay of the pole by anaerobic bacteria as hereinabove envisaged.

It must be appreciated that the specific configurations of both embodiments of the field liner of the invention as above described are greatly variable, whilst still incorporating the essential features of the two field liners which facilitate the convenient application thereof onto timber poles. Also, the material types forming the layers of the sheet element of which the field liners are formed are greatly variable and particularly will be determined by particular applications of field liners and particular conditions to which poles having field liners fitted thereon may be exposed, in use.

The field liners as described render application onto poles significantly easier and quicker than when compared with the application of known field liners onto poles, thus facilitating the use of field liners and the provision of field liners, e.g. in a roll form, or the like.

1. A field liner for protecting a timber pole against subsoil decay, which includes a sheet element in the form of a laminate structure including a first layer of a flexible, liquid impermeable, non-biodegradable synthetic plastics film material that contains a dry film biocide therein and a second layer of a flexible, liquid impermeable, non-biodegradable synthetic plastics film material that is tear resistant, the sheet element being configured to permit wrapping thereof around a pole for covering the region of the pole to be protected and having an adhesive substance applied thereto in a region thereof that permits securing of the location of the sheet element on a pole when wrapped around the pole with its first layer abutting the pole by adhering the said region of the sheet element to an opposing region of the sheet element when wrapped around the pole.

2. A field liner as claimed in claim 1, in which the sheet element is configured to define a rectangular configuration, that permits wrapping thereof around a pole by winding it on the pole, and the adhesive substance is applied thereto as an adhesive strip along an operative longitudinal edge region thereof.

3. A field liner as claimed in claim 2, in which the sheet element is provided on a roll including a plurality of sheet elements, being separable from the roll by severing along a defined line of weakness.

4. A field liner as claimed in claim 1, in which the sheet element is configured to define an elongate sleeve that has the first layer of material forming the operative inside thereof and the second layer of material forming the operative outside thereof and that permits loose location on a pole for covering the region of the pole to be protected and hence wrapping around the pole into a tight configuration of the sheet element on the pole, the second layer of material having an adhesive substance applied externally thereon in a region thereof that permits securing of the location of the sheet element in its said tight configuration on a pole when wrapped around the pole by adhering the said region to an opposing region of the sheet element when wrapped around the pole in the said tight configuration thereof.

5. A field liner as claimed in claim 4, in which one end of the sleeve defined by the sheet element is at least partially sealed to form a pocket, the at least partially sealed end of the sleeve, in use, serving to determine the location of the sleeve on a pole by preventing the butt end of the pole to extend beyond the said at least partially sealed end of the sleeve.

6. A field liner as claimed in claim 4, in which the sheet element, in its configuration in which it defines an elongate sleeve, is provided on a roll including a plurality of such sheet elements, being separable from the roll by severing along a defined line of weakness.

7. A field liner as claimed in claim 1, in which the first layer of the sheet element is formed of polypropylene film.

8. A field liner as claimed in claim 1, in which the dry film biocide contained in the first layer of the sheet element is of a type that provides for the protection of the sheet element against preservative-resistant micro organisms.

9. A field liner as claimed in claim 1, in which the first layer of the sheet element contains an insecticide compound therein.

10. A field liner as claimed in claim 9, in which the insecticide compound is the pyrethroid insecticide, Deltamethrin.

11. A field liner as claimed in claim 1, in which the second layer of the sheet element is formed of one of low density polyethylene and high density polyethylene.

12. A field liner as claimed in claim 11, in which the second layer of material is formed of high density polyethylene that permits crimping of a segment of the sheet element that, in use, extends beyond the butt end of a pole around which the sheet element is wrapped.

13. A field liner as claimed in claim 1, in which the second layer of the sheet element contains an insecticide compound.

14. A field liner as claimed in claim 13, in which the insecticide compound is the pyrethroid insecticide, Deltamethrin.

15. A field liner as claimed in claim 1, which includes a third layer formed of a flexible aluminium film that is vapour impermeable and that is laminated between the said first layer and the said second layer of the sheet element.

16. A field liner as claimed in claim 1, in which the adhesive substance comprises an adhesive sealant.

17. A field liner as claimed in claim 1, in which the adhesive substance is covered by a peel-off strip that can form a part of the field liner and that can be peeled-off prior to or during application of the field liner onto a pole.

18. A roll of field liners, as claimed in claim 1, in which the sheet elements of the field liners form the roll and are separable from the roll by severing thereof along defined lines of weakness.

19. In combination, a pole and a field liner as claimed in claim 1, with the field liner applied to the pole.

20. (canceled)
